(19) United States
(12) Patent Application Publication
(10) Pub. No.: US 2010/0198532 A1
(43) Pub. Date: Aug. 5, 2010

(54) APPARATUS AND METHOD FOR MEASUREMENT OF TUBE INTERNAL DIAMETER

(76) Inventors: Weston Gerwin, Perrysburg, OH (US); Michael Sterling Lynch, Fostoria, OH (US); Kirk Heckathorn, Tiffin, OH (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/640,474

(22) Filed: Dec. 17, 2009

Related U.S. Application Data
(60) Provisional application No. 61/141,475, filed on Dec. 30, 2008.

(51) Int. Cl. G01B 13/08; G01F 1/34; G06F 19/00

(52) U.S. Cl. 702/47; 702/157

(57) ABSTRACT

A method and apparatus for determining the theoretical internal diameter of a tube of unknown internal diameter comprising an air regulation system comprising a pressure regulator and a volumetric flow meter for obtaining an actual volumetric flow rate through the tube of unknown internal diameter. Calculating a theoretical volumetric flow rate for a range of tubes of known internal diameters. Calculating the theoretical internal diameter of the tube of unknown internal diameter, wherein the actual volumetric flow rate obtained from the apparatus is interpolated with the respective theoretical volumetric flow rates of the tubes of known internal diameter to obtain the theoretical internal diameter of the tube of unknown internal diameter.

### CROSS-REFERENCE TO RELATED APPLICATION

This application claims the benefit of U.S. Provisional Application Ser. No. 61/141,475, filed on Dec. 30, 2008, the contents of which are incorporated by reference herein.

### TECHNICAL FIELD

Exemplary embodiments of the invention relate to the measurement of tubes having small internal diameters. More particularly, this invention relates to a method and apparatus for measuring the internal diameter of tubes having diameters in the range of about 0.04 inches and below.

### BACKGROUND

The impact of flow characteristics in tubing is desirable in many applications. Such applications include the timed release of small quantities of fluid. The tube internal diameter may impact the flow characteristics of a fluid such as volumetric flow rate, inlet and outlet pressure, temperature and other factors. Known methods and apparatus for measuring the internal diameter of tubes less than 0.040 inches may suffer from repeatability issues and are generally thought to be inaccurate. Such methods and apparatus may be costly due to timely mastering requirements.

Accordingly, it is desirable to provide a method and apparatus for measuring the internal diameter of uniform internal diameter tubes of less than about 0.04 inches.

### SUMMARY OF THE INVENTION

In an exemplary embodiment, an apparatus for determining a theoretical internal diameter of a tube of unknown internal diameter comprises a compressed fluid supply, a wand configured to fluidly engage the tube of unknown internal diameter and a compressed fluid regulation system disposed between the compressed fluid supply and the wand. The compressed fluid regulation system includes a pressure regulator, a volumetric flow meter and a conduit configured to provide fluid communication between the compressed fluid supply, the compressed fluid regulation system and the wand. The volumetric flow meter is configured to measure an actual volumetric flow rate of compressed fluid through the tube of unknown internal diameter for interpolation with volumetric flow rates of known internal diameter tubes to obtain the theoretical internal diameter of the tube.

### DESCRIPTION OF DRAWINGS

The invention, in accordance with preferred and exemplary embodiments, together with further advantages thereof, is more particularly described in the following detailed description taken in conjunction with the accompanying drawings in which:

FIG. 1 is a Moody diagram, wherein the resistance coefficient is a function of the Reynolds number and the relative roughness of a tube;

FIG. 2 is a plot of Mach number versus the distance along a tube;

FIG. 3 is a plot of Mach number versus the pressure ratio;

FIG. 4 is a chart of Mach number and ratio of static pressure and total pressure;

FIG. 5 is a table of calculations to obtain the resistance coefficients for tubes of known internal diameter;

FIG. 6 is a table of calculations to obtain the theoretical volumetric flow rate for tubes of known internal diameter; and

FIG. 7 is a schematic of an apparatus to obtain an actual volumetric rate of a tube.

### DESCRIPTION OF EXEMPLARY EMBODIMENTS

An apparatus configured for determining the theoretical internal diameter of a tube comprises a supply of pressurized fluid such as air, a wand configured to fluidly engage a tube of unknown internal diameter, an air regulation system disposed between the compressed air supply and the wand. The air supply, the air regulation system and the wand are in fluid communication with the tube of unknown internal diameter. An actual volumetric flow rate of air flow through the tube of unknown internal diameter is determined and is interpolated with a theoretical volumetric flow rate of a tube of known internal diameter to obtain the theoretical internal diameter of the tube.

A method for calculating the theoretical internal diameter of a tube of unknown internal diameter comprises the steps of calculating a resistance coefficient for a range of tubes of known internal diameter. Calculating an initial Mach number for each tube of known internal diameter. Calculating an absolute gauge pressure for each tube of known internal diameter. Calculating a mass flow rate for each tube of known internal diameter. Calculating a gauge density for each tube of known internal diameter. Calculating a theoretical volumetric flow rate for each tube of known internal diameter. Applying the apparatus configured for determining the theoretical internal diameter of a tube of unknown internal diameter to obtain an actual volumetric flow rate therethrough. Calculating the theoretical internal diameter of the tube of unknown internal diameter, wherein the actual volumetric flow rate obtained from the apparatus is interpolated with tubes of known internal diameters and respective volumetric flow rates to obtain the theoretical internal diameter of the tube of unknown internal diameter.

Exemplary examples and embodiments of the present invention are directed to a method and apparatus for calculating a theoretical internal diameter of a tube of unknown internal diameter. Through application of a flow of dry, compressible fluid at a predetermined pressure to one end of the tube of unknown internal diameter, such that the fluid flow reaches a terminal velocity before exiting the tube, the theoretical internal diameter of the tube can be calculated using the governing laws of compressible flow in a tube with friction. In one non-limiting exemplary embodiment the compressed fluid is compressed air and will be referred to as compressed air throughout the description. When a compressed air temperature, a tube length, an air pressure at the tube inlet, an internal roughness of the tube and a maximum attainable volumetric flow rate through the tube are known, one can calculate the theoretical internal diameter of the tube. As discussed in further detail, this method is particularly advantageous for calculating the theoretical internal diameter of tubes with diameters smaller than about 0.040 in.

Exemplary embodiments of the present invention comprise the application of governing laws of compressible flow in a tube with friction to thereby obtain resistance coefficients and maximum attainable theoretical volumetric flow rates for a group or a range of tubes having known internal diameters and subsequently calculating a theoretical internal diameter of a tube of unknown internal diameter having a known volumetric flow rate. More specifically, the resistance coefficient for a group or range of tubes with known internal diameters is calculated. The calculated resistance coefficients are used to calculate maximum attainable theoretical volumetric flow rates of the tubes of known internal diameter. An apparatus that may include a pressure regulator, a volumetric flow meter and a source of compressed air is used to apply a predetermined pressure and temperature of compressed air through the tube of unknown diameter such that an actual volumetric flow rate through the tube of unknown internal diameter is obtained. The actual volumetric flow rate of the tube of unknown internal diameter is compared to the volumetric flow rates calculated for the range of tubes of known internal diameter. The actual volumetric flow rate obtained from the apparatus for measuring the flow rate through the tube of unknown internal diameter is interpolated with the theoretical volumetric flow rates calculated for the next highest or the next lowest known tubes of known internal diameter to obtain a theoretical internal diameter of the tube of unknown internal diameter based on its actual measured volumetric flow rate.

In a non-limiting, example of the present invention, calculating the resistance coefficient f of a tube of known internal diameter comprises applying a series of equations relating to the governing laws of compressible flow in a tube over a range of known internal diameters. By knowing a total temperature of the air, T_{Total}; an air pressure at the tube exit of a tube of known internal diameter P_{Exit}; an ideal gas constant of air, k_{Air}; a specific gas constant of air, R_{Air}; a dynamic viscosity of air, ν_{Air}; an absolute roughness of the tube of known internal diameter, e; and the known internal diameter of the tube, D, one can calculate a temperature at the tube exit,

$${T}_{Exit} = {T}_{Total} ( \frac{2}{K + 1} ) ;$$

a speed of sound at the tube exit, C_{Exit}=\sqrt{k·R·T_{Exit}}; an air density at the tube exit,

$${ρ}_{Exit} = \frac{{P}_{Exit}}{R \cdot {T}_{Exit}} ;$$

a mass flow rate through the tube,

$$\dot{m} = {C}_{Exit} \cdot {ρ}_{Exit} \cdot \frac{Π}{4} D ;$$

a Reynolds number,

$${R}_{e} = \frac{{C}_{Exit} \cdot D}{{v}_{Air}}$$

and a relative roughness of the tube, ε/D, applying a Moody chart will obtain the resistance coefficient f for the tube of known internal diameter (D).

As an example, compressed air is theoretically supplied through a tube inlet to reach a terminal velocity at the tube exit, T_{Total}=295 K (22° C.); P_{Exit}=101×10³ Pa (14.16 psi); k_{Air}=1.4 and R_{Air}=287 J/kg·K. Subsequently, the governing laws of compressible flow in a tube obtain the following values:

$${T}_{Exit} = 295 K ( \frac{2}{1.4 + 1} ) = 246 K ;$$

$${C}_{Exit} = \sqrt{1.4 \cdot 287 J \text{/} kg \cdot K \cdot 246 K} = 314 m \text{/} s$$

$$and$$

$${ρ}_{Exit} = \frac{101 kPa}{287 J / kg \cdot K \cdot 246 K} = 1.43 k g \text{/} {m}^{3} .$$

For the same example, the resistance coefficient is calculated for a range or group of tubes of known internal diameters of 0.016 in. (4.064×10⁻⁴ m), 0.015 in. (3.81×10⁻⁴ m), 0.014 in. (3.556×10⁻⁴ m), 0.013 in. (3.302×10⁻⁴ m), 0.012 in. (3.048×10⁻⁴ m) and 0.011 in. (2.794×10⁻⁴ m), wherein υ=1.10×10⁻⁵ m²/s (Air at T_{Total}); e=6.0×10⁻⁵ in.; T_{Exit}=246K; C_{Exit}=314 m/s and ρ_{Exit}=1.43 kg/m³. For a tube having a known internal diameter D of 0.016 in. (4.064×10⁻⁴ m), the governing laws of compressible flow in a tube obtain the following values:

$$\begin{matrix}\dot{m} = 314 m \text{/} s \cdot 1.43 kg \text{/} {m}^{3} \cdot ( \frac{Π}{4} \cdot 4.064 \times {10}^{- 4} m ) \\ = 0.00349 kg \text{/} min ;\end{matrix}$$

$${R}_{eExit} = \frac{314 m \text{/} s \cdot 4.064 \times {10}^{- 4} m}{1.10 \times {10}^{- 5} {m}^{2} \text{/} s} = 11 \text{,} 600 ;$$

$$and$$

$$Relative roughness = \frac{6.0 \times {10}^{- 5} in}{0.0160 in} = 0.0038 .$$

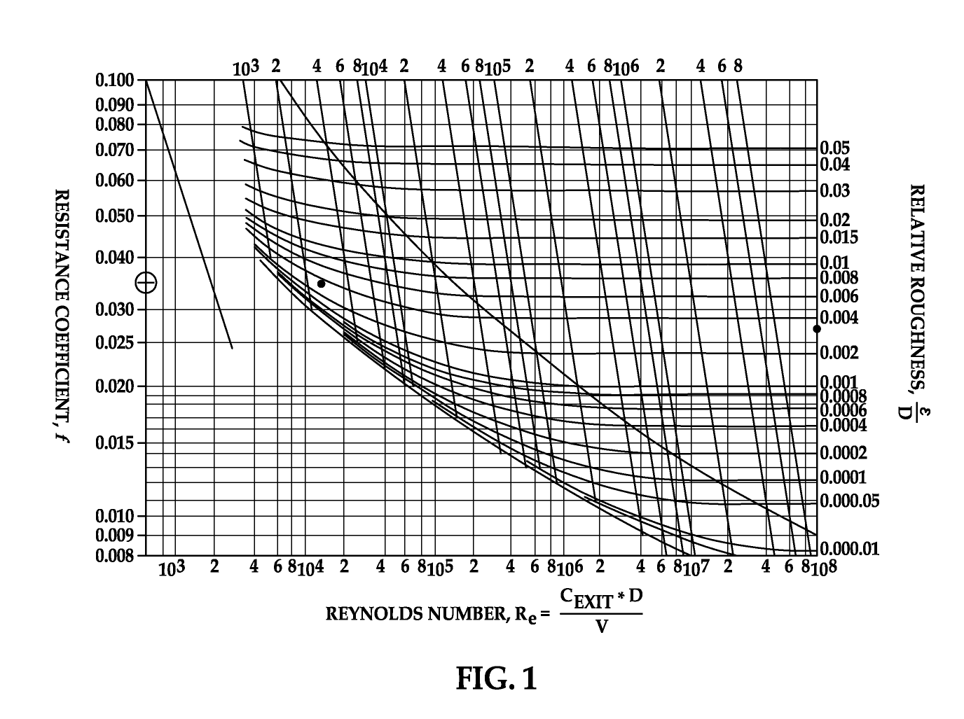

Referring to FIG. 1, a Moody chart is used to determine the resistance coefficient f, wherein the resistance coefficient f is a function of the Reynolds number and the relative roughness of a tube having an internal diameter D of 0.016 in. (4.064×10⁻⁴ m). Applying the Moody chart, the resistance coefficient f is determined using the Reynolds number and the Relative roughness of the tube. In the present example, a tube having an internal diameter D of 0.016 in., a Reynolds number of 11,600 and a Relative roughness of 0.0038 yields a resistance factor f of 0.035. Likewise, incorporating the same method and calculations as described above, the resistance coefficients for the following internal diameter tubes 0.015 in., 0.014 in., 0.013 in., 0.012 in. and 0.011 in. are determined to be 0.036, 0.037, 0.038, 0.039 and 0.040, respectively.

The resistance coefficients obtained for the range of tubes of known internal diameter may be used to calculate the maximum attainable theoretical volumetric flow rates of the tubes. To calculate the maximum attainable theoretical volumetric flow rate,

$${V}_{Gauge} = \frac{\dot{m}}{{ρ}_{Gauge}} ,$$

the following values must first be determined: an initial Mach number, M_{Initial}; a pressure at the initial Mach number, P_{M}; a ratio of static pressure to total pressure, P/P_{T}; a gauge pressure, P_{Gauge}; and a gauge density, ρ_{Gauge}. The values used in the preceding example to obtain the resistance coefficients can be used to calculate the maximum attainable theoretical volumetric flow rates for each tube of known internal diameters.

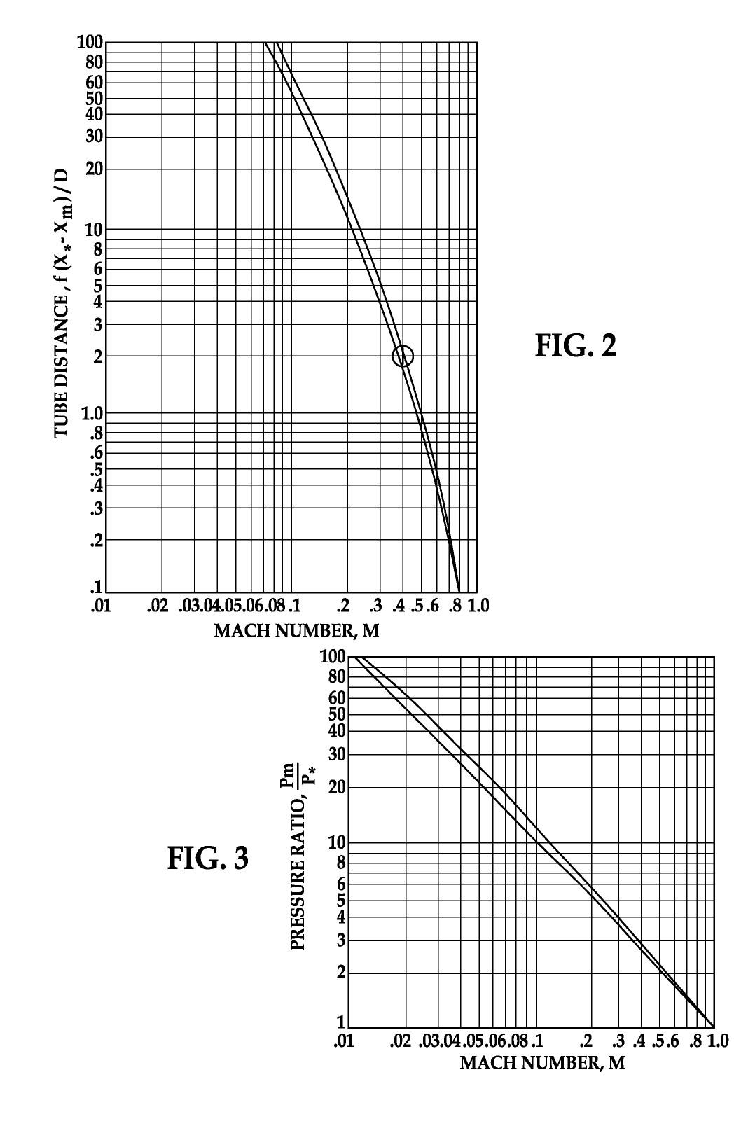

Referring to FIG. 2, the initial Mach number, M_{Initial}, must first be calculated for compressed air entering a tube inlet and reaching terminal velocity before exiting the tube. When a flow is subsonic, the Mach number will increase with distance along the pipe. It is not possible for the Mach number of a compressible flow in a pipe to change from subsonic to supersonic. Consequently, the maximum Mach number that an initially subsonic flow can attain is unity at the outlet of the pipe, wherein unity is a subsonic flow reaching a supersonic flow, and having a value of M=1.0. In the present invention, where the initial flow of the compressed air is subsonic, the initial Mach number, M_{Initial}, is obtained by first calculating the distance along a pipe with respect to the internal diameter of the pipe, f(x_{*}−xₘ)/D , wherein x_{*} is the distance of the tube where the Mach number reaches unity and xₘ is the distance where the initial Mach number is attained. Thus, the Mach number reaches unity at the exit of the tube and the internal Mach number is attained when the compressed air enters the tube, xₘ=0.

In a non-limiting example, the tube length is 0.02332 m for each of the range of tubes of known internal diameter and therefore an initially subsonic flow reaches unity at the end of the tube, x_{*}=0.02332 m. The initial Mach number is calculated by corresponding the distance along a pipe with the curve corresponding to k_{Air}=1.4. Here, the distance along the tube is f(x_{*}−xₘ)/D=0.35(0.02332 m−0)/4.043×10⁻⁴ m=2. As shown in FIG. 2 and referring to the plot of initial Mach number versus the distance along a tube with respect to the internal diameter of the tube, the initial Mach number, M_{Initial}, is 0.42 with respect to the resistance coefficient, f=0.35, calculated and determined from the known internal diameter, D=0.016 in. This method of obtaining the initial Mach number is repeated to calculate initial Mach numbers determined to be 0.41, 0.40, 0.38, 0.37 and 0.36 for the known internal diameters 0.015, 0.014, 0.013, 0.012 and 0.011 in. and the resistant coefficients 0.036, 0.037, 0.038, 0.039 and 0.040, respectively.

The initial Mach numbers previously calculated and determined are used to calculate the pressure located at a respective initial Mach number, P_{M}. Referring to FIG. 3, the plot shown illustrates the initial Mach number versus the pressure ratio, P_{M}/P_{*}, wherein P_{*} is the pressure at Mach number unity. It being understood that P_{*}=P_{Exit} because the compressed air enters the tube inlet as a subsonic fluid, wherein the compressed air can only achieve unity at the tube exit.

In an example, P_{*}=101 kPa and P_{M} corresponds to the pressure at the initial Mach number, wherein P_{0.42} corresponds to the pressure at the initial Mach number having a value of 0.42 with respect to the known internal diameter of 0.016 and the resistance coefficient of 0.35 previously attained. Referring to the plot shown in FIG. 3, an initial Mach number of 0.42 yields a pressure ratio of 2.6 on the curve corresponding to

$${k}_{Air} = 1.4 . \\ Hence , \frac{{P}_{0.42}}{101 kPa} = 2.6 ,$$

and therefore, P_{0.42}=2.6(101 kPa)=263 kPa. This method of obtaining the pressure, P_{M}, at the initial Mach number is repeated to obtain the pressures of 268, 273, 288, 293 and 303 kPa located at the initial Mach numbers of 0.41, 0.40, 0.38, 0.37 and 0.36 for the known internal diameters of 0.015, 0.014, 0.013, 0.012 and 0.011, respectively.

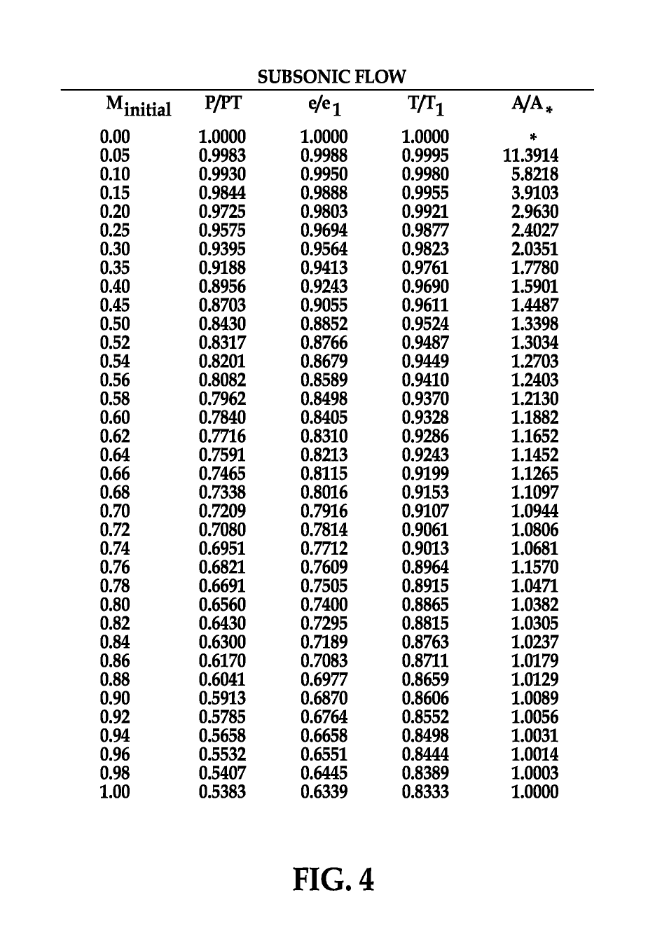

The pressures at the initial Mach numbers, P_{M}, previously determined are used in association with the ratio of static pressure to total pressure, P/P_{T}, to calculate the absolute gauge pressure, P_{Gauge}, located at the tube inlet for the range of tubes of known internal diameter. The ratio of static pressure to total pressure, P/P_{T}, is a ratio of pressure inside the tube without velocity of a fluid passing through. Referring to FIG. 4, when the value of M_{Initial} is determined, the pressure ratio, P/P_{T} is readily calculated by matching the P/P_{T} value to a respective M_{Initial} value. Once P/P_{T} is determined, the gauge pressure, P_{Gauge}, can be calculated by determining the ratio between P/P_{T} and P_{M},

$$\frac{{P}_{M}}{\frac{P}{{P}_{T}}} .$$

In a non-limiting example, a 0.016 in. inner diameter tube yields an initial Mach number, M=0.42; a P_{0.42}=₂₆₃ kPa and a P/P_{T}=0.8855, wherein

$${P}_{Gauge} = \frac{{P}_{M}}{\frac{P}{{P}_{T}}} = \frac{263 kPa}{0.8855} = 297 kPa .$$

This method of calculating and determining the gauge pressure at the tube inlet is repeated to obtain the gauge pressures of 301, 305, 318, 324 and 333 kPa for the internal diameters of 0.015, 0.014, 0.013, 0.012 and 0.011, respectively.

The gauge pressures, P_{Gauge}, previously attained are used to calculate the gauge densities, ρ_{Gauge}, wherein the gauge densities are further used in association with the mass flow rates (previously attained in the resistance coefficient f calculations), \dot{m}, to calculate the maximum attainable theoretical volumetric flow rates V_{Gauge}. First,

$${ρ}_{Gauge} = \frac{{P}_{Gauge}}{R \cdot {T}_{Total}} ,$$

wherein the value of ρ_{Gauge} is used to obtain the maximum attainable theoretical volumetric flow rate,

$${V}_{Gauge} = \frac{\dot{m}}{{ρ}_{Gauge}} .$$

The method of calculating P_{Gauge} and V_{Gauge} is repeated for the range of tubes having known internal diameters.

In a non-limiting example of the present invention, the values previously attained for the inner diameter 0.016 in. are used in association with the governing laws of compressible flow in a tube with friction to calculate

$${ρ}_{Gauge} = \frac{268 kPa}{287 J \text{/} kg \cdot K \cdot 246 K} = 3.51 kg \text{/} {m}^{3}$$

$$and$$

$${V}_{Gauge} = \frac{0.00349 kg \text{/} min}{3.51 kg \text{/} {m}^{3}} = 0.994 L \text{/} min ,$$

wherein this method is repeated to calculate ρ_{Gauge} values of 3.56, 3.60, 3.76, 3.83 and 3.93 kg/m³ and V_{Gauge} values of 0.862, 0.744, 0.614, 0.514 and 0.425 L/min for known internal diameters of 0.015, 0.014, 0.013, 0.012 and 0.011, respectively.

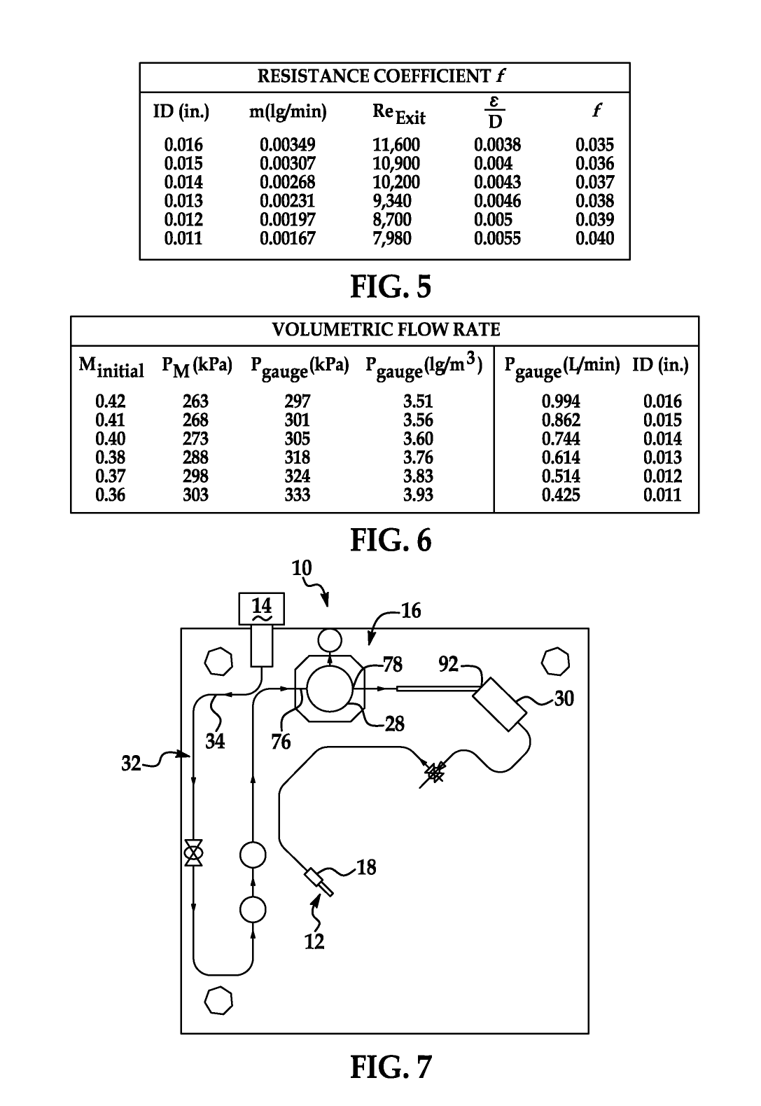

Thus far, exemplary examples of the present invention have incorporated the governing laws of compressible flow in a tube with friction to obtain resistance coefficients f and maximum attainable theoretical volumetric flow rates for a group or range of tubes having known internal diameters. The range of the tube diameters is chosen so that it is broad enough to encompass an internal diameter of a tube of unknown diameter being tested to determine the theoretical internal diameter thereof. As illustrated in FIGS. 5 and 6, the values for the resistance coefficients and the theoretical volumetric flow rates obtained in the example correspond to the respective known internal tube diameters.

FIG. 6 may be used to correlate new values obtained from measuring the actual volumetric flow rate of compressed gas flowing through a tube of unknown internal diameter and reaching terminal velocity at the tube exit. The measured volumetric flow rate will be compared with charted theoretical volumetric flow rates displayed. Subsequently, by methods of interpolation, the theoretical internal diameter of the tube of unknown internal diameter can be calculated. Incorporating this method and apparatus is particularly advantageous for measuring internal diameters smaller than about 0.04 inches wherein known measuring techniques are of questionable reliability.

Referring to FIG. 7, exemplary embodiments of the present invention are directed to a flow measuring apparatus 10 configured for determining the theoretical internal diameter of a tube of unknown internal diameter 12. The flow measuring apparatus 10 comprises a compressed air supply 14 fluidly connected to an air regulation system 16 and a wand 18. The wand is configured for fluid engagement with the tube of unknown internal diameter 12. The air regulation system 16 is disposed between the compressed air supply 14 and the wand 18 and may include a pressure regulator 28 and a volumetric flow meter 30. An air conduit system 32, defines a path for fluid communication between the compressed air supply 14, the air regulation system 16 and the wand 18. As such, compressed air is provided by the compressed air supply 14 to the tube of unknown diameter 12 through the flow measuring apparatus 10.

The compressed air supply 14 may be provided by a pump or a tank and, in non-limiting alternative embodiments of the present invention, the compressed fluid may be any compressed gas including helium, hydrogen, nitrogen, carbon dioxide, natural gas, or other suitable compressed gases.

In an exemplary embodiment of the present invention, and referring to FIGS. 7 and 8, the airflow 34 from the compressed air supply 14 enters the pressure regulator 28 via inlet 76. The pressure regulator 28 is configured to reduce the pressure of the airflow 34 delivered by the compressed air supply 14. In a non-limiting exemplary example, the pressure regulator 28 provides pressure at 40 PSI to correspond to the gauge pressures, P_{Gauge}, obtained from the range of tubes of known internal diameter and calculated in the preceding examples (FIGS. 1-3).

In an exemplary embodiment of the present invention, and referring again to FIG. 7, the airflow 34 exits the pressure regulator 28 via the pressure outlet 78 and enters the volumetric flow meter 30, through inlet 92. The volumetric flow meter 30 is configured to measure the absolute pressure, the temperature, the actual volumetric flow rate and the actual mass flow rate of the compressed air flow 34 that enters the tube of unknown internal diameter through the wand 18, wherein the values used and obtained from the theoretical calculations of P_{Exit}, T_{Total}, \dot{m} and V_{Gauge} correspond to the those values. The volumetric flow meter 30 operates to measure the actual volumetric flow rate through the tube of unknown internal diameter 12. Obtaining the actual volumetric flow rate is advantageous because it is used in association with the theoretical volumetric flow rates obtained from the governing laws of compressible flow in a pipe (See FIGS. 5-6A) to calculate the theoretical internal diameter thereof.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims and their legal equivalence.

1. An apparatus for determining a theoretical internal diameter of a tube of unknown internal diameter comprising:
a compressed fluid supply;
a wand configured to fluidly engage the tube of unknown internal diameter;
a compressed fluid regulation system disposed between the compressed fluid supply and the wand, the compressed fluid regulation system comprising a pressure regulator and a volumetric flow meter;
a conduit configured to provide fluid communication between the compressed fluid supply, the compressed fluid regulation system and the wand, wherein the volumetric flow meter is configured to measure an actual volumetric flow rate of compressed fluid through the tube of unknown internal diameter for interpolation with volumetric flow rates of known internal diameter tubes to obtain the theoretical internal diameter of the tube of unknown internal diameter.

2. The apparatus of claim 1, wherein the compressed fluid may be any compressed gas including air, helium, hydrogen, nitrogen, carbon dioxide, natural gas or a combination thereof.

3. The apparatus of claim 1, wherein the volumetric flow meter operates to measure the absolute pressure, the exit temperature, the volumetric flow rate and the actual mass flow rate of the compressed fluid flowing through the tube of unknown internal diameter.

4. A method for calculating the theoretical internal diameter of a tube of unknown internal diameter (tube), the method comprising the steps of:
calculating an air temperature at a tube exit, wherein a known air temperature at a tube inlet and an ideal gas constant of air are provided;
$${T}_{Exit} = {T}_{Total} ( \frac{2}{k + 1} )$$
calculating a speed of sound value at the tube exit, wherein the calculated air temperature at the tube exit, a specific gas constant of air and the ideal gas constant of air are provided;
C_{Exit}=\sqrt{k·R·T_{Exit}}
calculating a relative roughness of the tube for a range of known internal diameters, wherein a known absolute roughness of the tube is provided;
$$RelativeRoughness = \frac{ɛ}{D}$$
calculating a Reynolds number at the tube exit for the range of known internal diameters, wherein the calculated value of the speed of sound at the tube exit and a known dynamic viscosity of air are provided;
$${R}_{{e}_{Exit}} = \frac{{C}_{Exit} \cdot D}{{υ}_{Air}}$$
calculating a resistance coefficient for the range of known internal diameters, wherein the resistance coefficient is a function of the calculated Reynolds number and the calculated relative roughness;
calculating a distance along a tube for the range of known internal diameters, wherein the length of the tube and the calculated resistance coefficient are provided;
f(x_{*}−xₘ)/D
calculating an initial Mach number for the range of known internal diameters, wherein the calculated distance along a tube and the ideal gas constant of air are provided;
calculating a pressure ratio for the range of known internal diameters, wherein the calculated initial Mach number and the ideal gas constant of air are provided;
calculating a pressure located at the calculated initial Mach number for the range of known internal diameters, wherein the calculated pressure ratio and the known exit pressure of the tube are provided;
Pₘ/P_{Exit}
applying a subsonic flow table of a ratio of static pressure to total pressure at a given Mach number to obtain a ratio of static pressure to total pressure inside the tube for the range of known internal diameters, wherein the calculated initial mach number is provided;
$${M}_{Initial} = \frac{P}{{P}_{T}}$$
calculating an absolute gauge pressure located at the inlet of the tube for the range of known internal diameters, wherein the calculated total pressure and the ratio of static pressure to total pressure located at the calculated initial Mach number are provided;
$${P}_{Gauge} = \frac{{P}_{M}}{\frac{P}{{P}_{T}}}$$
calculating an exit density, wherein a known exit pressure, the specific gas constant of air and the calculated exit temperature are provided;
$${ρ}_{Exit} = \frac{{P}_{Exit}}{R \cdot {T}_{Exit}}$$
calculating a mass flow rate for the range of known internal diameters, wherein the calculated speed of sound at the tube exit, the calculated exit density and a known internal diameter are provided;
$$\dot{m} = {C}_{Exit} \cdot {ρ}_{Exit} \cdot \frac{Π}{4} D$$
calculating a gauge density for the range of known internal diameters, wherein the calculated absolute pressure, the specific gas constant of air and the known total temperature are provided;
$${ρ}_{Gauge} = \frac{{P}_{Gauge}}{R \cdot {T}_{Total}}$$
calculating a theoretical volumetric flow rate for the range of known internal diameters, wherein the calculated mass flow rate and the calculated gauge density are provided;
$${V}_{Gauge} = \frac{\dot{m}}{{ρ}_{Gauge}}$$
providing an apparatus configured to apply pressurized air through the tube having an unknown internal diameter to obtain an actual volumetric flow rate through the tube; and
calculating the theoretical internal diameter of the tube having an unknown internal diameter, wherein the actual volumetric flow rate obtained from the apparatus is interpolated with the theoretical volumetric flow rate to obtain the theoretical internal diameter of the tube having an unknown internal diameter.

5. A method for calculating the theoretical internal diameter of a tube having an unknown internal diameter, the method comprising the steps of:
calculating a resistance coefficient for a plurality of tubes of known internal diameter, wherein the known internal diameters are within a range of known internal diameters;
calculating a distance along each tube of known internal diameter within the range of known internal diameters, wherein the length of the tube and the calculated resistance coefficient for each tube of known internal diameter within the range of known internal diameters is provided;
calculating an initial Mach number for each tube of known internal diameter within the range of known internal diameters, wherein the distance along each tube of known internal diameter within the range of known internal diameters is provided;
calculating an absolute gauge pressure for each tube of known internal diameter within the range of known internal diameters, wherein the initial Mach number for each tube of known internal diameter within the range of known internal diameters is provided;
calculating a mass flow rate for each tube of known internal diameter within the range of known internal diameters;
calculating a gauge density for each tube of known internal diameter within the range of known internal diameters, wherein the calculated absolute gauge pressure and the total temperature is provided;
calculating a theoretical volumetric flow rate for each tube of known internal diameter within the range of known internal diameters is provided;
providing an apparatus configured to apply compressed air through an internal diameter of a tube having an unknown internal diameter to obtain an actual volumetric flow rate through the tube; and
calculating the theoretical internal diameter of the tube of unknown internal diameter, wherein the actual volumetric flow rate obtained from the apparatus is interpolated with the theoretical volumetric flow rates to obtain the theoretical internal diameter of the tube of unknown internal diameter.
